(19) United States
(12) Patent Application Publication
(10) Pub. No.: US 2026/0087935 A1
(43) Pub. Date: Mar. 26, 2026

(54) Providing Scanning Assistance at a Point-of-Sale

(71) Applicant: ZEBRA TECHNOLOGIES CORPORATION, Lincolnshire, IL (US)

(72) Inventors: Darran Michael Handshaw, Sound Beach, NY (US); Andrea Mirabile, London (GB); Edward Barkan, Miller Place, NY (US)

(21) Appl. No.: 18/895,173

(22) Filed: Sep. 24, 2024

(51) Int. Cl. G09B 5/02; G06Q 20/20

(52) U.S. Cl. CPC G09B 5/02; G06Q 20/208

(57) ABSTRACT

Devices, systems, and methods for providing assistance during use of a data capture device are disclosed. One example method includes capturing, by the data capture device, images of an object and associated indicia that results in a non-decode. The method may provide the images to a first model to determine a cause of the non-decode, obtain scanning instructions associated with resolving the cause of the non-decode, and output the scanning instructions to an output device. Another example method may include capturing images of an object and providing the images to a second model to determine object classifications of the object. The method may obtain object instructions associated with scanning the object, and output the object instructions to an output device.

### BACKGROUND

A customer or otherwise user may have difficulty successfully scanning an item during checkout at a point-of-sale (POS) due to the item's packaging and/or barcode. In one example, the item's barcode and/or packing may include reflective material (e.g., foil, glass, etc.) that, when illuminated by a data capture device (e.g., an indica scanner) when capturing images of the barcode, may cause reflections or other issues affecting the ability of the POS and/or data capture device to decode the barcode. In another example, the barcode may be affixed to the surface of a round item such as a stick of lip balm, such that portions of the barcode are out of the field of view of the data capture device when capturing images of the lip balm. Capturing only a portion of the lip balm's barcode may also cause a non-decode of the barcode. In yet another example, the barcode may include unusual symbology or be printed using low contrast ink, resulting in a non-decode of the barcode.

The user may scan an item several times in an attempt to decode the barcode and resolve the scanning issue caused by the barcode and/or object, expending computing resources with each scan and/or non-decode of the barcode, such as power to operate the data capture device and/or POS, memory resources to capture one or more images of the item and/or indicia, processing resources to process the images for decoding the barcode, network resources to transmit the images, etc. Resolving the scanning issue generally requires retail staff to intervene and provide customer service at checkout, expending time and resources of the retailer's staff. Moreover, the scanning issue causes both frustration and delay for the user checking out, as well as for other users waiting to checkout at the POS, until the scanning issue is resolved.

Accordingly, there is a need for improved systems and methods for providing assistance during use of the data capture device.

### SUMMARY

In an embodiment, a system for providing assistance during a use of a data capture device is disclosed. The system may include one or more processors; and a memory storing instructions that, when executed by the one or more processors, cause the one or more processors to: (i) capture, by the data capture device, one or more images comprising image data of an object within a field of view of the data capture device, wherein: the object is associated with an indicia that is captured in the image data, and analysis of the one or more images results in a non-decode of the indicia; (ii) provide at least a portion of the image data to a first model configured to determine a cause of the non-decode; (iii) based upon the cause of the non-decode, obtain scanning instructions indicating a scanning action to be performed, wherein the scanning action is associated with resolving the cause of the non-decode of the indicia; and (iv) output, via an output device, the scanning instructions.

In a variation of the embodiment, the cause of the non-decode may include one or more of: a distance of the indicia from the data capture device, symbology of the indicia, a substrate of the indicia, a size of the indicia, an incomplete indicia, or contrast of the indicia.

In another variation of the embodiment, the cause of the non-decode may be the symbology of the indicia, and the system may further include instructions that, when executed by the one or more processors, cause the one or more processors to obtain symbology data to decode the symbology of the indicia.

In yet another variation of the embodiment, the system may further include instructions that, when executed by the one or more processors, may cause the one or more processors to: based upon the non-decode, change an operational characteristic of the data capture device associated with one or more of: illumination, a focal setting, an image sensor setting, or image processing.

In still yet another variation of the embodiment, the scanning action may be associated with a location of the object respective to a scanning area and/or a position of the object during image capture.

In a variation of the embodiment, the scanning instructions may include one or more of: audio, an image, text, video, and/or an indication of a scanning location.

In another variation of the embodiment, the first model may include a neural network.

In yet another variation of the embodiment, the system may further include instructions that, when executed by the one or more processors, may cause the one or more processors to: (i) initiate a manual entry function of a user interface associated with the data capture device; (ii) receive, via the user interface, object information associated with a known object; (iii) identify the object based upon the captured image data of the object; (iv) determine whether the object is the known object based upon the object information and identifying the object; (v) responsive to the object being the known object, cause a point-of-sale device to receive a payload including the object information from the data capture device; and (vi) responsive to the object not being the known object, cause the point-of-sale device to perform an intervention operation.

In a variation of the embodiment, the intervention operation includes one or more of: requesting user assistance, providing instructions, preventing user operation of a point-of-sale, or changing operational characteristics of the data capture device.

In another variation of the embodiment, the system may further include instructions that, when executed by the one or more processors, cause the one or more processors to: determine whether the scanning instructions are performed; and responsive to the scanning instructions not being performed, cause a point-of-sale device to perform an intervention operation.

In another embodiment, a method for providing assistance during a use of a data capture device is disclosed. The method may include (i) capturing, by the data capture device, one or more images comprising image data of an object within a field of view of the data capture device, wherein: the object is associated with an indicia that is captured in the image data, and analysis of the one or more images results in a non-decode of the indicia; (ii) providing at least a portion of the image data to a first model configured to determine a cause of the non-decode; (iii) based upon the cause of the non-decode, obtaining scanning instructions indicating a scanning action to be performed, wherein the scanning action is associated with resolving the cause of the non-decode of the indicia; and (iv) outputting, via an output device, the scanning instructions.

In yet another embodiment, a system for providing assistance during a use of a data capture device is disclosed. The system may include one or more processors; and a memory storing instructions that, when executed by the one or more processors, cause the one or more processors to: (i) capture, by the data capture device, one or more images comprising image data of an object within a field of view of the data capture device; (ii) provide at least a portion of the image data to a second model configured to determine one or more object classifications associated with the object; (iii) based upon the one or more object classifications, obtain object instructions indicating an object action to be performed, wherein the object action is associated with scanning the object across a scanning area within the field of view of the data capture device; and (iv) output, via an output device, the object instructions.

In a variation of the embodiment, the one or more object classifications may be based upon one or more of: a characteristic of packaging of the object, a characteristic of an indicia associated with the object, a size of the object, or a shape of the object.

In another variation of the embodiment, the system may further include instructions that, when executed by the one or more processors, cause the one or more processors to: based upon the one or more object classifications, change an operational characteristic of the data capture device associated with one or more of: illumination, a focal setting, an image sensor setting, or image processing.

In yet another variation of the embodiment, to provide the image data to the second model may be responsive to one or more of: exceeding a threshold number of image captures of the object without a successful decode of an associated indicia, exceeding a threshold time for scanning the object without the successful decode of the associated indicia, or a missed scan event.

In still yet another variation of the embodiment, the object action may be associated with an adjustment of packaging of the object and/or a position of the object during image capture.

In a variation of the embodiment, the object instructions may include one or more of: audio, an image, text, video, and/or an indication of a scanning location.

In another variation of the embodiment, the second model may include a neural network.

In yet another variation of the embodiment, the system may further include instructions that, when executed by the one or more processors, cause the one or more processors to: (i) initiate a manual entry function of a user interface associated with the data capture device; (ii) receive, via the user interface, object information associated with a known object; (iii) identify the object based upon the captured image data of the object; (iv) determine whether the object is the known object based upon the object information and identifying the object; (v) responsive to the object being the known object, cause a point-of-sale device to receive a payload including the object information from the data capture device; and (vi) responsive to the object not being the known object, cause the point-of-sale device to perform an intervention operation.

In a variation of the embodiment, the intervention operation may include one or more of: requesting user assistance, providing instructions, preventing user operation of a point-of-sale, or changing operational characteristics of the data capture device.

In still yet another variation of the embodiment, the object instructions may be output to the output device before scanning of the object across the scanning area.

In another variation of the embodiment, the system may further include instructions that, when executed by the one or more processors, cause the one or more processors to: determine whether the object instructions are performed; and responsive to the object instructions not being performed, cause a point-of-sale device to perform an intervention operation.

In still yet another embodiment, a method for providing assistance during a use of a data capture device is disclosed. The method may include: (i) capturing, by the data capture device, one or more images comprising image data of an object within a field of view of the data capture device; (ii) providing at least a portion of the image data to a second model configured to determine one or more object classifications associated with the object; (iii) based upon the one or more object classifications, obtaining object instructions indicating an object action to be performed, wherein the object action is associated with scanning the object across a scanning area within the field of view of the data capture device; and (iv) outputting, via an output device, the object instructions.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A illustrates a perspective view of an example indicia reader that may be used to implement inventive concepts described here.

FIG. 1B illustrates a perspective view of another example barcode reader that may be used to implement inventive concepts described here.

FIG. 1C illustrates a perspective view of yet another example barcode reader that may be used to implement inventive concepts described here.

FIG. 1D illustrates a profile view of an example scanning system that may be used to implement inventive concepts described here.

FIG. 2A is a block diagram of an example computing environment for providing assistance during a use of a data capture device, in accordance with embodiments described herein.

FIG. 2B is an image of an example barcode printed on a reflective substrate, according to embodiments described herein.

FIG. 2C illustrates an example display of scanning instructions, according to embodiments described herein.

FIG. 2D is an image of an example object having malleable packaging, according to embodiments described herein.

FIG. 2E illustrates an example display of object instructions, according to embodiments described herein.

FIG. 3A illustrates a first example method for providing assistance during a use of a data capture device, according to embodiments described herein.

FIG. 3B illustrates a second example method for providing assistance during a use of a data capture device, according to embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As previously mentioned, the type of packaging and/or indicia (e.g., barcode) of an item can cause an unsuccessful decode of the indicia, also referred to at times herein as an a “non-decode,” “unsuccessful scan,” “failed scan,” and similar. In addition to causing frustration for the user scanning the item, the unsuccessful decode requires the retailer to utilize their limited retail staff to resolve the scanning issue causing the non-decode. Moreover, each non-decode results in the unnecessary expenditure of computing resources (e.g., power, processing resources, memory resources, network resources) by the data capture device and/or POS performing the unsuccessful decode.

Therefore, it is an objective of the present disclosure to provide systems and methods for providing assistance during use of the data capture device to reduce or eliminate a non-decode of the item's indicia. As a result, data capture devices, imaging systems, barcode scanners, bioptic indicia readers, POS systems, and the like may operate more efficiently by reducing or eliminating the computing resources otherwise required during each scan and non-decode of the indicia.

It should be understood that, while the indicia and indicia scanning/decoding methods are referenced herein primarily as a barcode and barcode scanning/decoding respectively, the systems and methods of the present disclosure may apply to any indicia (e.g., quick response (QR) codes, a graphic, a logo, etc.) associated with an object. Moreover, and as will be understood by a skilled artisan, the techniques of the systems and methods disclosed herein may apply to indicia scanning/decoding as well as other implementations which may not necessarily include indicia scanning/decoding, such as object recognition and/or others readily apparent to those of ordinary skill in the art having the benefit of the description herein.

In particular, the techniques of the present disclosure provide solutions to the aforementioned issues experienced with conventional data capture devices, imaging systems, indicia readers, barcode scanning devices, POS systems, and the like during unsuccessful decodes of an item's indicia, such as the expenditure of computing resources during a scan and subsequent non-decode. The techniques of the present disclosure alleviate these issues by introducing systems and methods for providing assistance during a use of a data capture device (also referred to as an imager, imaging assembly, imaging device, and similar) configured to capture image data comprising one or more images of an object within the field of view (FOV) of the data capture device. In at least some embodiments, the data capture device may capture the images during one or more scans of the object across a scanning area that result in a non-decode of the object's indicia captured in the images, such as an indicia affixed to the object's packaging. A first model (e.g., a neural network) may receive at least a portion of the image data to determine a cause of the non-decode. An output device (e.g., a display, a speaker, a computing device) may output scanning instructions that are obtained based upon the cause of the non-decode. The scanning instructions may indicate one or more scanning actions to be performed (e.g., by the customer, retail staff) to resolve the cause of the non-decode. In one example, if the first model determines the cause of the item's barcode non-decode is related to the distance of the item and/or the item's indicia from the data capture device (e.g., the item is too far from the scanning area, the barcode is very small requiring scanning at a close distance), the scanning action may include moving the object closer to the scanning area during scanning. In another example, the barcode may be folded over onto itself such that first model determines the non-decode is a result of the barcode appearing incomplete when it is scanned. The associated scanning action to resolve the non-decode may include unfolding the barcode.

In at least some embodiments, the data capture device may capture one or more images of the object within its FOV, such as during scanning or even before scanning. In such embodiments, a second model may receive at least a portion of the images to determine one or more object classifications associated with the object, such as more object classifications based upon characteristics of the object's packaging and/or indicia, the object's size, the object's shape, and/or other suitable characteristics of the object. The output device may output object instructions that are obtained based upon one or more of the object's classifications. The object instructions may indicate an object action to be performed that is associated with scanning the object across a scanning area within the data capture device's FOV, so that the scan may result in a successful decode of the associated indicia. In one example, the barcode may be affixed to an object having foil packaging, the object may be classified by the second model as a highly reflective object, and the object instructions may include an object action to scan the object's barcode at an angle to mitigate reflections from the illuminated foil during image capture. In another example, the object may be a six-sided pencil having a barcode applied around all six sides of the pencil such that only a portion of the barcode is viewable on each side of the pencil. The second model may classify the object as having a problematic shape, and the associated object instructions may include an object action that the pencil be slowly rotated over the scanning area so that the image capture device captures all six sides of the pencil and the entire barcode affixed thereto.

By determining the cause of an indicia non-decode using a first model and/or the classification of an object using a second model based upon captured object images, the techniques of the present disclosure allow indicia-specific and/or object-specific instructions respectively to be provided to the user during checkout to mitigate or altogether avoid decode issues. Accordingly, the present disclosure includes improvements in computer functionality associated with decoding indicia by describing techniques for capturing an image of an object, using a first model to determine the cause of a non-decode and provide associated instructions for resolving the cause of the non-decode, and/or using a second model to classify the object and provide associated instructions for scanning the object. That is, the present disclosure describes improvements in the functioning of scanning/imaging systems and devices, and also improves the associated the state of the art, at least because conventional scanning/imaging systems and devices typically lack the enhancements described in the present disclosure, including without limitation, enhancements relating to determining the cause of a non-decode and providing instructions associated with resolving the non-decode, and determining the classification of an object and providing instructions associated with scanning the object, both of which mitigate or avoid non-decodes of the object's indicia, as described throughout the present disclosure.

In addition, the present disclosure includes applying various features and functionality, as described herein, with, or by use of, a particular machine, e.g., a data capture device, an output device, a user interface, and/or other components as described herein.

Moreover, the present disclosure includes specific features other than what is well-understood, routine, conventional activity in the field, or adding unconventional steps that demonstrate, in various embodiments, particular useful applications. In one embodiment, capturing, by the data capture device, one or more images comprising image data of an object within a FOV of the data capture device, wherein the object is associated with an indicia that is captured in the image data, and analysis of the one or more images results in a non-decode of the indicia; providing at least a portion of the image data to a first model configured to determine a cause of the non-decode; based upon the cause of the non-decode, obtaining scanning instructions indicating a scanning action to be performed, wherein the scanning action is associated with resolving the cause of the non-decode of the indicia; and outputting, via an output device, the scanning instructions. In another embodiment, capturing, by the data capture device, one or more images comprising image data of an object within a FOV of the data capture device; providing at least a portion of the image data to a second model configured to determine one or more object classifications associated with the object; based upon the one or more object classifications, obtaining object instructions indicating an object action to be performed, wherein the object action is associated with scanning the object across a scanning area within the FOV of the data capture device; and outputting, via an output device, the object instructions.

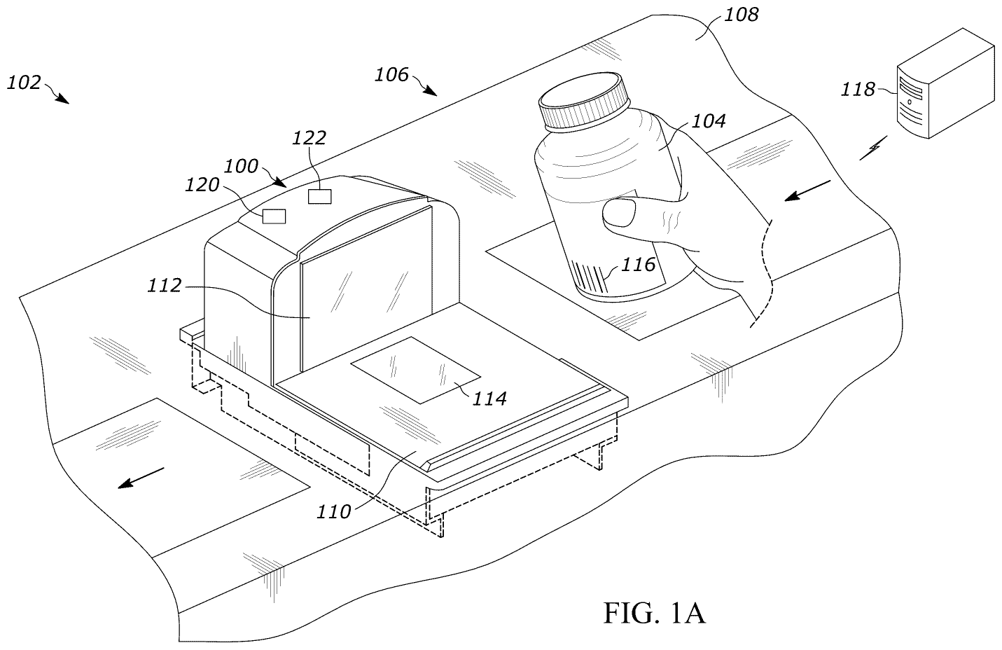

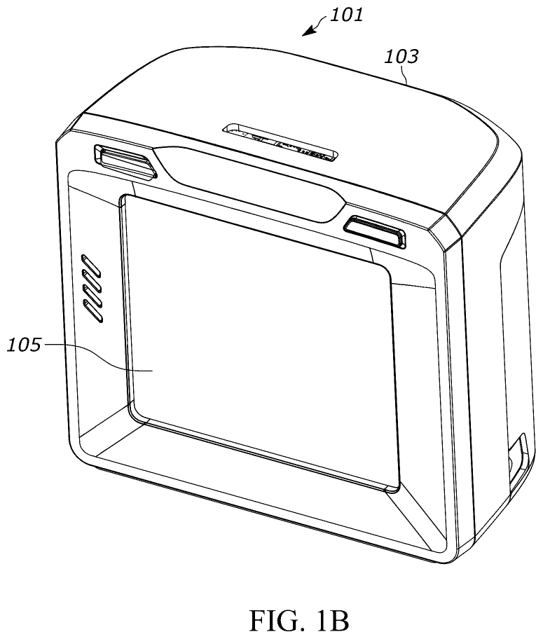

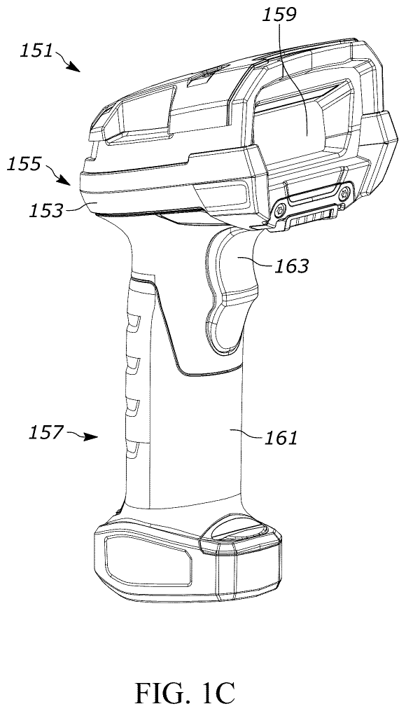

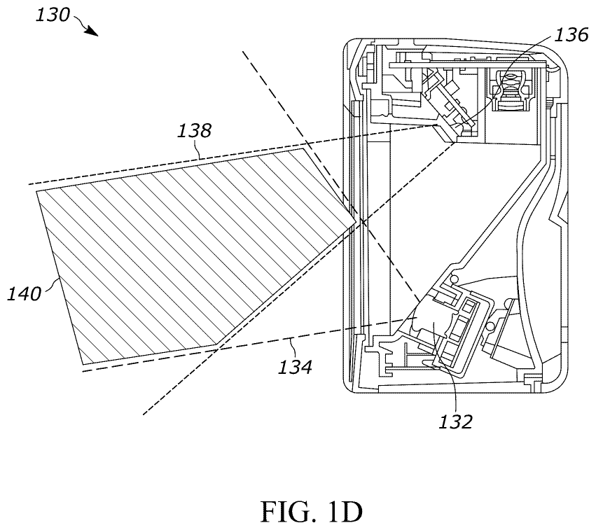

FIG. 1A is a perspective view of a bioptic indicia reader 100 (e.g., data capture device), implemented in a POS system 102, depicting the capture of an image of a target object 104 being swiped across the scanning area indicia reader 100. The POS system 102 includes a workstation 106 with a counter 108, the indicia reader 100, and a weighing platter 110. Typically, a customer or store clerk will pass the target object 104 from in a general direction, in the illustrated example right-to-left, across at least one of a substantially vertical imaging window 112 or a substantially horizontal imaging window 114 to enable the indicia reader 100 to capture one or more images of the target object 104, including the barcode 116.

When passing the target object 104 across the imaging windows 112, 114, the indicia reader 100 may trigger an illumination source 120 included in the indicia reader 100 to emit illumination, and for an imaging sensor 122 to capture image data comprising one or more images of the target object 104 and/or the barcode 116. The indicia reader 100 is operable to capture image data of sufficient quality to perform imaging-based operations like decoding a barcode 116 that appears in the captured image data. It should be appreciated that while items may be passed across, also referred to as “scanning,” the indicia reader 100 in either direction, items may also be presented into the product scanning area by means other than swiping past the window(s). When the target object 104 comes into the any of the fields of view of the indicia reader 100, the barcode 116 on the target object 104 is captured and decoded by the indicia reader 100, and corresponding data (e.g., the payload of the indicia) is transmitted to a communicatively coupled host 118, commonly comprised of a point-of-sale (POS) terminal.

FIG. 1B illustrates another example of an indicia reader 101, sometimes referred to as a slot scanner. In the example shown, indicia reader 101 has a housing 103 and a window 105, which faces a product scanning area, to allow a set of optical components positioned within housing 103 to direct at least one field-of-view through window 105. Indicia reader 101 operates on a similar principle as the indicia reader 100 of FIG. 1A. However, it is generally smaller (typically having a window that is smaller than 5 inches across), includes a single window, and, while it could be installed in a slot of a counter (functioning like the bottom portion of the bioptic indicia reader 100), it can also be used as a stationary scanner positioned on a working surface (functioning like the upper portion of the bioptic indicia reader 100).

FIG. 1C illustrates yet another example of an indicia reader 151, sometimes referred to as a handheld indicia reader. Reader 151 generally includes a housing 153 that is comprised of a head portion 155 and a bottom portion 157. The head portion 155 houses at least some optoelectrical components for capturing relevant image data along a FOV that extends through a window 159. The bottom portion 157 typically includes a handle portion 161 and a trigger 163. In operation, a user typically grasps the handle portion 161 and points the reader 151 in a general direction of the indicia that is to be read. If the reader is configured to be activated with the activation of the trigger 163, subsequent to the user squeezing the trigger 163, reader 151 captures relevant image data and processes it accordingly.

While it will be appreciated that concepts described herein may be used in connection with any of the indicia reader embodiments described above, this should not be considered limiting and it should be understood that other form factors of indicia readers could be employed.

FIG. 1D depicts a profile view of an imaging system, in accordance with embodiments described herein. Generally speaking, the imaging system may be implemented via a bioptic indicia reader 130, although other scanning systems may be within the scope of the invention.

As depicted in FIG. 1D, the bioptic indicia reader 130 may include a first imaging assembly 136 (e.g., data capture device) configured to capture one or more images comprising image data. In some embodiments, the first imaging assembly 136 may be implemented with one or more vision cameras. In certain embodiments, the first imaging assembly 136 (e.g., vison camera) may be oriented to have a first FOV 138 of the scanning area. The bioptic indicia reader 130 may include a second imaging assembly 132 (e.g., data capture device) configured to capture one or more images comprising image data. The second imaging assembly 132 may include a scanner that is configured to detect and decode barcodes and/or other object indicia (e.g., barcode reader). In some embodiments, the second imaging assembly 132 may be implemented with a dedicated indicia scanner, such as a indicia reader 100 of FIG. 1A, to detect and/or decode barcodes of items scanned for purchase.

In some embodiments, the multiple imaging assemblies may be a single imaging assembly with a single imaging sensor (e.g., a single imaging sensor configured for barcode scanning and visual imaging). The single imaging assembly may have a single FOV of objects passing over the scanning area and may be configured for indicia decoding and visual imaging (e.g., machine vision analysis) of the images captured by the single imaging assembly. In some embodiments, each and/or both of the imaging assemblies 132, 136 may include multiple image sensors which process images in the same/similar manner, and/or may operate collectively, e.g., to produce an image. In such an example, each of the multiple image sensors may have a slightly different FOV, such that the FOV 134, 138 described above may be and/or include the multiple FOVs of the multiple image sensors. For example, first imaging assembly 136 may have four images sensors, each with a slightly different FOV, and are configured to collectively capture an image in the FOV 138. The FOVs 134, 138 may create an overlap region 140.

The indicia reader 100 may store image data in a memory, such as a local memory, a remote memory such as a database on a host 118 (e.g., POS, server) communicatively coupled to the indicia reader 100, and/or in any other suitable memory.

In some embodiments, the indicia reader 100 and/or any other suitable processing device and/or component of, or communicatively coupled to, the indicia reader 100 may include and/or execute an application, module, algorithm, model (e.g., a neural network, machine learning model), and the like to detect, track, identify and/or compare objects which have passed though the scanning area and/or FOV of a data capture device, decode an indicia, determine the cause of a non-decode, classify an object, and/or any other suitable function.

The indicia reader 100 and/or other suitable processor(s) may analyze image data to decode an indicia captured within image data. In an example, an image processing application of the indicia reader 100 may decode the barcode when the processor loads an indicia decoder from memory to process the first image data. The indicia may comprise an encoded indicia value as, for example, is the case with a 1D or 2D barcode where the barcode encodes an indicia value comprised of, for example, alphanumeric or special characters that may be formed into a string. Decoding the indicia associated with the object in the image data may result in a decoded indicia value. In one aspect, analyzing the image data and/or decoding an indicia may include extracting, via the indicia decoder (also referred to as an indicia decoding module), an image processing unit, or other suitable component, an indicia payload associated with an indicia present in image data. For example, decoding the indicia may include optical character recognition of letters, numbers and/or other symbology of the indicia, or any other suitable manner of extracting a payload from an indicia. In at least some aspects, the indicia payload may indicate a class of items (e.g., cereal, dairy, produce, or any other suitable class of items). The class of items indicated by the indicia payload (e.g., a decoded indicia value) may be associated with items which are frequently used in a ticket switch, frequently stolen, have requirements for purchase (e.g., an age restriction), or other suitable classification.

The indicia reader 100 may transmit a decoded indicia value to a host (e.g., host 118), such as a POS system. For example, the decoded indicia value may be used by the POS system to tally items a user is scanning with the bioptic indicia reader 130 for purchase during a scan session, to identify that a scanned item belongs to a class of items, such as ticket switching items, etc.

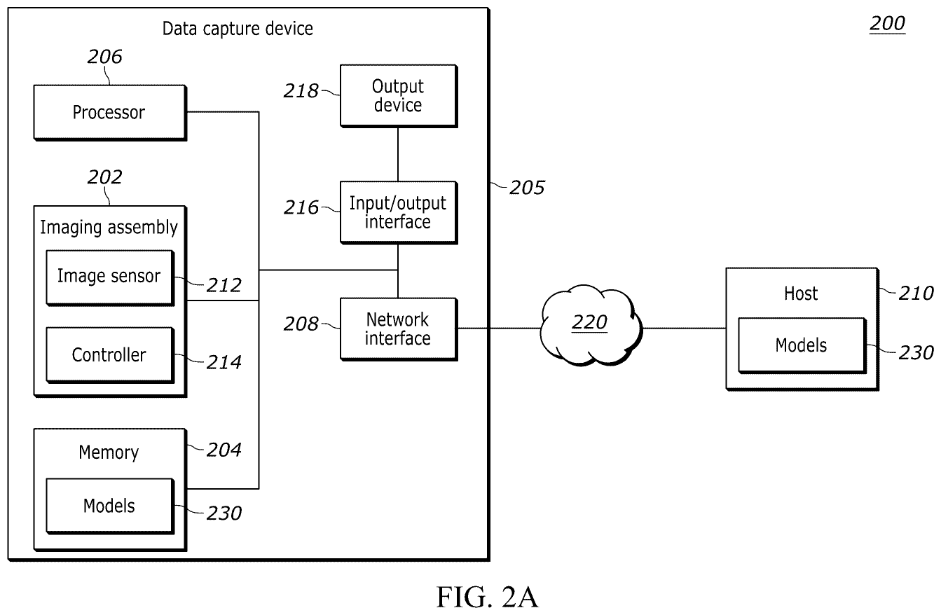

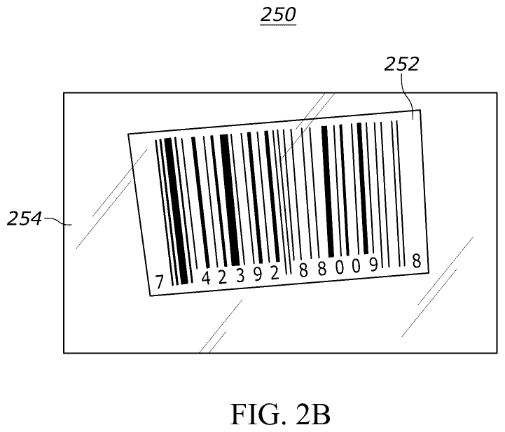

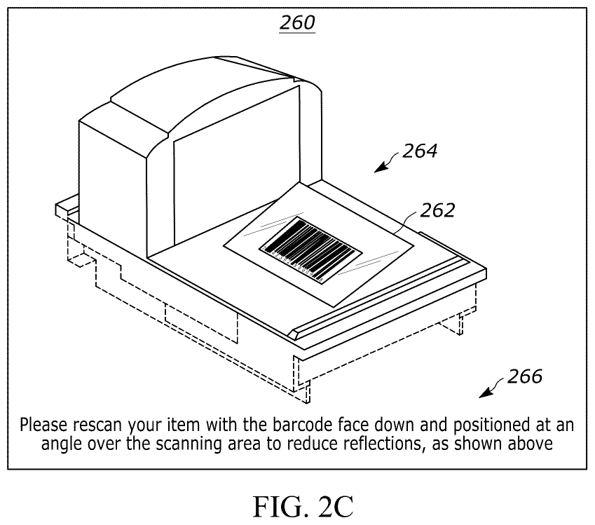

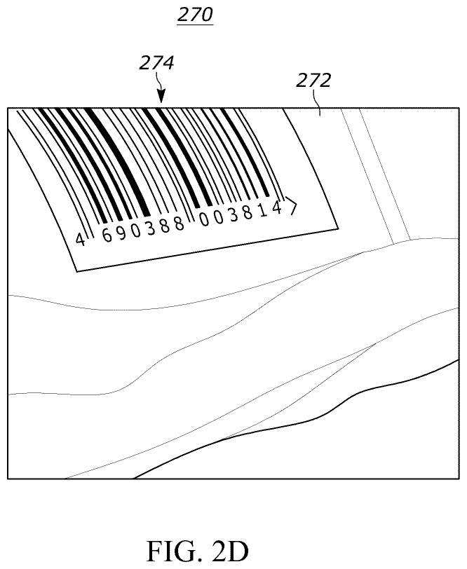

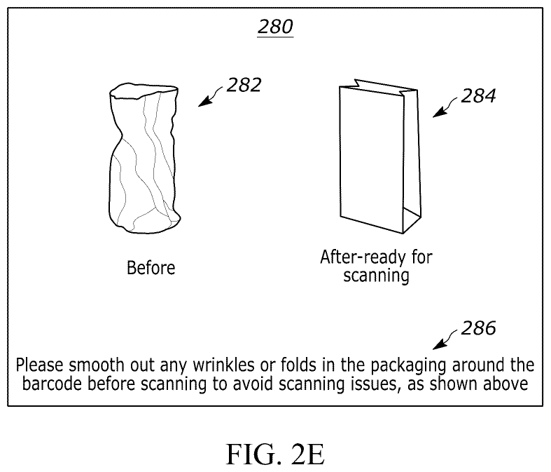

FIG. 2A illustrates a block diagram of an example computing environment 200 for providing assistance during a use of a data capture device, in accordance with embodiments described herein. The computing environment 200 may include computing devices such as a data capture device 205 and a host 210 (e.g., POS, server) connected by a network 220. Although the computing environment 200 is shown to include one data capture device 205, one host 210 and one network 220, it should be understood that the computing environment 200 may include additional, fewer, and/or alternate components, and may be configured to perform additional, fewer, or alternate actions, including components/actions described herein. Similarly, while the data capture device 205 and host 210 are shown to include certain components, it should likewise be understood that the data capture device 205 and host 210 may include additional, fewer, and/or alternate components, and also may be configured to perform additional, fewer, and/or alternate actions, including the components and/or actions described herein. For example, the computing environment 200 may include a plurality of data capture devices 205, all of which may be interconnected via the network 220. Similarly, the data capture device 205 may include multiple processors 206, and may not include an I/O interface 216. Moreover, various aspects of the computing environment 200 may include any suitable additional component(s) not shown in FIG. 2A, and/or omit component(s) shown in FIG. 2A, such as but not limited to the example components described herein. Furthermore, it should be appreciated that additional and/or alternative connections between components shown in FIG. 2A may be implemented. As just one example, the data capture device 205 and the host 210 may be connected via a direct communication link (not shown in FIG. 2A) instead of, or in addition to, via the network 220.

The data capture device 205 may include an imaging assembly 202, a memory 204, a processor 206, a network interface 208, an I/O interface 216, and an output device 218, any and/or all of which may be interconnected via an address/data bus or otherwise communicatively connected.

The imaging assembly 202, such as the imaging assembly of indicia readers 100, 130, may include at least one image sensor 212 and a controller 214. In particular, the at least one image sensor 212 may be configured to capture image data comprising one or more images of the FOV, e.g., a FOV including a target object, a scanning area, etc. The at least one image sensor 212 may be and/or include a charge-coupled device (CCD) sensor, a complementary metal-oxide semiconductor (CMOS) sensor, a one-dimensional array of addressable image sensors, a two-dimensional array of addressable image sensors, a monochrome sensor, a color sensor, and/or any other suitable image sensor. Depending on the implementation, the at least one image sensor 212 may include a color sensor such as a vision camera in addition to and/or as an alternative to the monochrome sensor. The imaging assembly 202 may include one or more subcomponents, such as one or more controllers 214, and/or one or more imaging shutters (e.g., electronic and/or mechanical shutters configured to expose/shield the imaging sensor 212 from the external environment). The one or more controllers 214 may control and/or perform operations of the imaging assembly 202. The controller 214, the processor 206, and/or other suitable component may be configured to control the imaging assembly 202. The imaging assembly may include and/or be communicatively coupled to an illumination source (e.g., the illumination source 120) configured to emit illumination during a (predetermined) period corresponding to capturing image data via the imaging assembly 202, such as white light illumination, particular wavelengths (e.g., red wavelengths, IR) to suit the requirements of the imaging assemblies, etc. The data capture device 205 may include one or more operational characteristics (e.g., via the processor 206, the controller 214) associated illumination (e.g., during image capture), a focal setting (e.g., focal distance to the object), an image sensor setting (e.g., contrast, resolution), image processing (e.g., image cropping, stitching), and/or other operational characteristics. An adjustment or otherwise change may be made to one or more of the operation characteristics of the data capture device 205, for example based upon the cause of the non-decode of the indicia and/or object classification of the object, and/or to mitigate or avoid a non-decode.

The imaging assembly 202 may be configured to capture image data which may comprise one or more images (e.g., two-dimensional images) of a target object within the FOV, including, for example, packages, items, labels, and/or other target objects, which some examples includes merchandise available at retail/wholesale store, facility, or the like. The target objects may or may not include indicia, such as a barcode, a QR codes, a digital watermark, and/or other such indicia. The controller 214, the processor 206, one or more models 230, the host 210, and/or other suitable component(s) of the example computing environment 200 may analyze the captured image data of target objects and/or indicia passing through a FOV of the imaging assembly 202, e.g., for decoding the indicia, object recognition/identification/classification, determining the cause of an indicia non-decode, and/or any other suitable purpose.

The data capture device 205 may include a memory 204 accessible by the processor 206 (e.g., via a memory controller), the imaging assembly 202 (e.g., via controller 214), and/or other components of the data capture device 205 and/or computing environment 200. The memory 204 may include one or more suitable storage media such as a magnetic storage device, a solid-state drive, random access memory, volatile memory, non-volatile memory, a database, and/or any other suitable memory. The memory 204 may be a local memory included within the housing of the data capture device 205. The memory may store image data, models, symbology data, and/or other suitable data. The memory 204 may contain instructions which may be executed by the processor 206. The instructions may include software applications, algorithms, modules, decoders, models (e.g., neural networks), images for updating models, and/or other suitable instructions.

The memory 204 may store one or more models 230, such as a machine learning model or neural network. In at least some implementations, the models 230 may include a first model configured to receive image data (e.g., images of indicia and/or objects captured by the data capture device 205), and determine a cause of the non-decode of the indicia based upon the image data. The first model may include a neural network, and/or any other suitable model. In at least some implementations, the models 230 may include a second model configured to receive image data (e.g., images of objects captured by the data capture device 205), and determine one or more object classifications associated with the object based upon the image data. The second model may include a neural network, and/or any other suitable model. It should be understood that although the first and second models are described as having certain functionalities, such functionalities may be performed by fewer or additional models. For example, a single model may receive image data as an input, and provide as an output a cause of an indicia non-decode and an object classification of an object. The models 230 may be configured to perform other functions (e.g., decoding of an indicia in the image data). The models 230 may be updated, also referred to training, retraining, and/or fine-tuning, especially in the context of a machine learning model. For example, in the context of using the second model to determine object classifications of an object, the second models may be updated to classify an unidentified item a retail store has never before carried. To update the second model, the computing device updating the model (e.g., the data capture device 205, host 210) may use images of the unidentified object and/or other suitable images or data. One or more devices of the computing environment 200 may store, configure, update, and/or operate the models 230, such as the data capture device 205 and/or host 210. For example, in some implementations, the host 210 may store one or more of the models 230 in a local memory (e.g., the memory 204), and the data capture device 205 may retrieve one or more of the models 230 from the memory 204 via the network 220 for execution locally on the data capture device 205. In other implementations, the data capture device 205 may capture image data which it transmits to the host 210 via the network 220 for input to one or more of the models 230 stored locally on the host 210.

The data capture device 205 may include the processor 206 may include one or more processors such as a microprocessor (μP), microcontroller, central processing units (CPU) and/or graphics processing unit (GPU) and/or any suitable type of processor. The processor 206 may include one or more logical processors (e.g., virtual execution unit(s) having one or more threads) and/or physical processors (e.g., hardware execution units having one or more cores) and may include multitasking and/or parallel processing. In at least some embodiments, the processor 206 may be configured to control the imaging assembly 202, execute the models 230, and/or control overall operations of the data capture device 205. For example, the processor 206 may interact with the memory 204 to obtain, execute, and/or store, data and/or instructions (e.g., machine-executable instructions) related to the imaging assembly 202, the models 230, and/or other component(s) of the computing environment 200. Additionally, or alternatively, machine-readable instructions corresponding to the example operations described herein may be stored on one or more removable media (e.g., a compact disc, a digital versatile disc, removable flash memory, etc.) that may be communicatively coupled to the data capture device 205 to provide access to the machine-readable instructions stored thereon. In particular, the instructions stored in the memory 204, when executed by the processor 206, may cause the processor 206 to receive and analyze data (e.g., image data) and signals generated by the imaging assembly 202. For example, the memory 204 may include one or more programs, algorithms, models, modules, and the like which may analyze the captured image data to generate an associated payload, determine the cause of a non-decode, classify an object, etc.

The data capture device 205 may include a network interface 208 to enable communication by the data capture device 205 with other computing devices (e.g., the host 210) and/or components via the network 220. The example network interface 208 may include any suitable type of communication interface(s) (e.g., wired and/or wireless interfaces) and be configured to operate in accordance with any suitable protocol(s). For example, in some embodiments, network interface 208 may transmit data or information (e.g., image data, payloads, etc.) between remote processor(s), the host 210, and/or other components of the data capture device 205 or computing environment 200.

The data capture device 205 may include input/output (I/O) interface 216 to enable receipt of input (e.g., via a user interface) and/or communication of output data (e.g., to an output device). For example, the user may provide input to the data capture device 205 via I/O to indicate the payload the data capture device 205 generates is authorized.

The data capture device 205 may include the output device 218. The output device 218 may be configured to receive (e.g., via the I/O interface 216) and/or output data scanning instructions, object instructions, and/or other suitable data. The data may include audio, video, images, texts, an indication of a scanning location, and/or other suitable data. The output device 218 may include one or more speakers, displays (e.g., LCD, LED, OLED), illumination devices/components (e.g., lights, LEDs), computing devices (e.g., mobile computing device, POS), and/or other suitable components to output data. It should be understood that although the output device 218 is depicted in FIG. 2A as a component of the data capture device 205, the output device 218 may be a component of the host 210 (e.g., a display of a POS), and/or otherwise communicatively coupled to the computing environment 200 (e.g., the display of a computing device of the user).

The computing environment 200 of FIG. 2A may include at least one communication and/or data network 220 to communicatively couple components of the computing environment 200, such as the data capture device 205, the host 210, and/or any other suitable device/component, via one or more communication interfaces, such as the network interface 208. The network 220 may comprise any suitable network or networks, including a local area network (LAN), wide area network (WAN), Internet, or combination thereof. For example, the network 220 may include a wireless cellular service (e.g., 4G, 5G, etc.). Generally, the network 220 enables bidirectional communication between components of the computing environment 200. In one aspect, the network 220 may comprise a cellular base station, such as cell tower(s), communicating to the one or more components of the computing environment 200 via wired/wireless communications based on any one or more of various mobile phone standards, including NMT, GSM, CDMA, UMMTS, LTE, 5G, or the like. Additionally, or alternatively, the network 220 may comprise one or more wired and/or wireless data buses, modems, routers, switches, or other such connection points communicating to the components of the computing environment 200, which may include wired and/or wireless communications based on any one or more of various standards, including by non-limiting example, IEEE standards (e.g., 802.3, 802.11b/g/n/ac/ax, etc.), Bluetooth, and/or the like.

The computing environment 200 of FIG. 2A may also include a host 210. In at least some implementations, the host may be, or include, one or more servers, POS devices (e.g., for purchasing retail items), and/or other suitable computing device(s). The host 210 may be configured to receive, store, transmit, analyze and/or otherwise process image data, a payload, the models 230, and/or any other suitable data. The host 210 may be in communication with the data capture device 205 and/or other component of the computing environment 200 via the network 220 and/or other suitable connection. In some implementations, the host 210 may include a memory (e.g., the memory 204) to store the models 230, image data, symbology data, and/or other data.

The computing environment 200 may provide assistance during use of the data capture device 205 including determining the cause of a non-decode. In at least some embodiments, the data capture device 205 may capture (e.g., via the imaging assembly 202) one or more images of an object (e.g., scanned across a scanning area during one or more scans) within the FOV of the data capture device 205. The object may be associated with an indicia (e.g., barcode 116) that is captured in the image data and results in a non-decode of the indicia during the one or more scans. In one example, the data capture device 205 may recognize (e.g., via analyzing images capture by the imaging assembly 202) that a customer has exceeded a time threshold trying to scan the same object, and/or exceeded a threshold on number of scans of the object across the scanning area, either of which may be associated with one or more non-decodes of the object's indicia. In another example, the customer may trigger (e.g., via the POS) a missed scan event, e.g., associated with loss prevention when the data capture device 205 detects movement of an object through the scanning area that does not result in a decode and is not subsequently scanned again.

The data capture device 205 may execute (e.g., via the processor 206) the first model (e.g., the models 230) that may be configured to determine a cause of the non-decode. Based upon receiving (e.g., from the imaging assembly 202, the memory 204) at least a portion of the image data, the first model may determine the cause of the non-decode. The cause(s) of the non-decode may include a barcode wrapped in reflective film, glossy barcode, or otherwise due to the substrate of the barcode; a curved barcode (e.g., on a curved surface), a barcode larger than the FOV of the data capture device 205, long barcode (e.g., the size of the barcode); unusual and/or difficult to swipe symbology (e.g., Aztec code); a low contrast barcode; a ripped, folded, crumpled, bent, damaged, missing and/or otherwise incomplete barcode; a small barcode and/or small barcode symbology that is too far away from the data capture device 205 to decode, a large barcode that is too near to the data capture device 205 to be completely imaged/decoded, and/or otherwise caused by the distance of the indicia from the data capture device 205, etc.

Based upon the cause of the non-decode, the data capture device 205 may obtain scanning instructions indicating one or more scanning actions to be performed. The data capture device 205 may obtain the scanning instructions from the memory 204, a database, the host 210, from the first model (e.g., the first model generating the scanning instructions) and/or other suitable source of scanning instructions. The scanning action may be associated with resolving the cause of the non-decode of the indicia, such as actions associated with the location of the object during scanning (e.g., closer or farther from the scanning area and/or data capture device 205), the orientation and/or position of the object during image capture (e.g., angled, tilted), movement of the object during scanning (e.g., slow rotation), adjusting the barcode (e.g., unfolding), and/or other suitable scanning action.

In at least some embodiments where the cause of the non-decode is the symbology of the indicia, the data capture device 205 may obtain (e.g., from the memory 204, a database, the host 210, and/or other suitable source) symbology data to decode the symbology of the indicia. For example, a barcode may include obscure symbology that is not often decoded by the data capture device 205 and/or host 210. The symbology data may allow the data capture device 205 to decode the obscure symbology the data capture device 205 otherwise would not be able to decode, resolving the issue of the non-decode. In such an embodiment, once the symbology is detected as the cause of the non-decode, the scanning instructions may include, for example, having the user confirm the type of symbology at a user interface e.g., by comparing whether the unusual symbology is similar to example symbology displayed at the output device 218. In another example, the scanning instructions may include directing the user to scan the item again once the data capture device 205 indicates it has obtained the symbology data that allows the data capture device 205 or other component to decode the symbology.

The data capture device 205 may output, via the output device 218 (e.g., speaker, display), the scanning instructions. The scanning instructions may include audio, video, one or more images, text, an indication of a scanning location, and/or other instructional guidance for the user regarding how to scan the object and/or indicia to cause a successful decode of the indicia. In one example, LEDs may be embedded a weigh platter of a POS device and may be used to indicate an ideal scan location, or illumination may be projected into an ideal scan location in the scanning area.

In at least some embodiments, the disclosed techniques may determine whether the scanning instructions are performed, for example by analyzing images of the user via the data capture device 205. If the scanning actions are not performed, the data capture device 205 may cause the POS to perform an intervention operation, such requesting customer service assistance for the user, replaying the scanning instructions, preventing use of the POS until the scanning instructions are performed, and/or any other suitable intervention operation.

FIG. 2B is an image 250 of an example barcode 252 printed on a reflective substrate 254 (e.g., plastic), according to embodiments disclosed herein. An illumination source (e.g., illumination source 120) may illuminate the reflective substrate 254 while the data capture device 205 captures images of the barcode 252 during scanning. The captured images of the barcode 252 may include reflections due to the illumination of the reflective substrate 254, resulting in a non-decode of the barcode 252 when scanned. The data capture device 205 may provide the captured images of the reflective barcode 252 to the first model. The first model may determine the reflectiveness of the barcode substrate 254 is the cause of the non-decode. The first model may generate scanning instructions associated with resolving the cause (e.g., reflections) of the non-decode, which the data capture device 205 may output to the output device 218. Although the data capture device 205 obtains the scanning instructions from the first model, the data capture device 205 may obtain the scanning instructions from any suitable source as previously described.

FIG. 2C is an example display 260 (e.g., the output device 218) of the scanning instructions to resolve the non-decode of the reflective barcode 252, according to embodiments disclosed herein. The scanning instructions include an image depicting an example barcode 262 positioned at an angle respective to the scanning area 264 of an example POS. Positioning the barcode 262 at an angle may reduce the reflectivity that causes the non-decode of the barcode 252. The display 260 of the scanning instructions also includes text 266 describing the suggested scanning action to be performed to resolve the non-decode.

In some embedment's, the computing environment 200 may provide assistance during use of the data capture device 205 that includes classifying the object the user will scan. The data capture device 205 (e.g., via the 202) may capture one or more images of the object when within the FOV of the data capture device 205. In at least some embodiments, the data capture device 205 may capture the images before the user has scanned the object, for example as the user is approaching the data capture device 205 with the object within the FOV of the data capture device 205. In such an example, the disclosed techniques can provide scanning guidance to the user before the user scans the object, which may provide the benefits of avoiding a potential non-decode of the indicia associated with the object that would otherwise frustrate the user, expend retail staff resources, and/or expend computing resources of the data capture device 205 or device of the computing environment 200 due to the non-decode. The data capture device 205 may execute (e.g., via the processor 206) the second model, and provide at least a portion of the captured images (e.g., from the imaging assembly 202, the memory 204) to the second model (e.g., the models 230). The second model may determine one or more object classifications associated with the object based upon the received image(s) of the object. An object classification may indicate a characteristic of the object's packaging, such as the packaging being reflective (e.g., foil, plastic) or malleable (e.g., bag of rice); a characteristic of an indicia of the object, such as an easily damaged such (e.g., a label printed and applied to a bag of cheese at a deli counter), a size of the object such as an unusually large object (e.g., a broom stick) or small object (e.g. a nail clipper), a shape of the object such as an abnormally shaped object (e.g., a stuffed animal), and/or other suitable classifications.

Based upon the one or more object classifications, the data capture device 205 may obtain (e.g., from the memory 204, a database, the host 210, and/or other suitable source) object instructions indicating one or more object actions to be performed. The object action may be associated with scanning the object across the scanning area within the FOV of the data capture device 205. The data capture device 205 may output the object instructions to the output device. The object instructions may include audio, video, one or more images, text, and/or other instructional guidance for the user regarding how to scan the object and/or indicia to cause a successful decode of the indicia.

FIG. 2D is an image 270 of an example object having malleable packaging, according to embodiments described herein. More specifically, the object is bag 272 (e.g., bag of chips) having a barcode 274 printed thereon. As depicted in the image 270, the bag 272 is deformed in a manner that causes portions of the associated barcode 274 to be folded, which may cause a non-decode if the barcode 274 is scanned while folded. As a user approaches the data capture device 205, the data capture device 205 may capture one or more images (e.g., via the imaging assembly 202) of the bag 272 once it is within the FOV of the data capture device 205. The data capture device 205 may provide at least some of the captured images of the bag 272 to the second model (e.g., the models 230). In response to receiving the images of the bag 272, the second model may classify the bag 272 as having malleable packaging. Based upon the malleable object classification of the bag 272, the second model may generate object instructions associated with scanning the bag 272. The data capture device 205 may output the object instructions to the output device 205. Although the data capture device 205 obtains the object instructions from the second model, the data capture device 205 may obtain the scanning instructions from any suitable source as previously described. Additionally, in embodiments where one or more of the scanning instructions, the object instructions, and/or the models 230 is stored and/or executed on a device that is not the data capture device 205, for example the host 210, the host 210 may cause the scanning instructions and/or the object instructions to be output to one or more suitable output device 218.

FIG. 2E illustrates an example display 280 (e.g., the output device 218) of the object instructions for scanning the bag 272, according to embodiments disclosed herein. The object instructions include a first image 282 of an example bag that is deformed and wrinkled, and a second image 284 of the example bag that is smoothed out. The second image 284 also includes an indication that the smoothed bag is ready for scanning. The display 280 of the object instructions also includes text 286 describing the suggested object action the be performed before scanning the bag.

In at least some embodiments, providing scanning assistance may include changing one or more operational characteristic of the data capture device 205, such as the illumination, a focal setting, an image sensor setting, image processing, and/or other suitable operational characteristic, as previously described. The operational characteristic may be associated with the cause of a non-decode, mitigating the cause of the non-decode, and/or resolving the cause of the non-decode. Returning to the example of FIG. 2B where the cause of the non-decode of the barcode 252 is reflectivity, the data capture device 205 may alter an illumination setting (e.g., less intense illumination, off-axis illumination) to mitigate the reflections caused by the illumination during scanning of the barcode 252.

In at least some embodiments, providing scanning assistance from scanning an object resulting in a non-decode may include initiating a manual entry function of a user interface (e.g., via the I/O interface 216) associated with the data capture device 205 and/or POS (e.g., the host 210). For example, the user interface may be a graphical user interface allowing a user to manually enter information that is provided to the data capture device 205 (e.g., via the I/O interface 216), the host 210 (e.g., via the network 220), and/or other component of the computing environment 200. Such embodiments may include receiving, via the user interface, object information associated with a known object (e.g., known to the data capture device 205 and/or POS, such as being identified in a database of known objects available for purchase via the POS). For example, a user at the POS may select an image of the previously scanned object from a menu, enter the barcode of the previously scanned object, and/or any other suitable information. The disclosed techniques may include identifying the object based upon the captured image data (e.g., via the data capture device 205) of the object (e.g., during the unsuccessful scan of the object), and determining (e.g., via object recognition of the scanned object) whether the object is the known object based upon the object information and the identification of the object. Responsive to the object being the same object as the known object, the POS (e.g., the host 210) may receive a payload including the object information from the data capture device 205 (e.g., the payload used to purchase the item via the POS). Responsive to the object not being the known object, the POS may perform an intervention operation, such as an intervention operation associated with the user of the POS receiving assistance (e.g., via a customer service request, being provided instructions), a loss prevention related operation (e.g., preventing use of the POS), changing operation characteristics of the data capture device 205 (e.g., illumination), etc.

In at least some embodiments, the disclosed techniques may determine whether the object instructions are performed, for example by analyzing images of the user via the data capture device 205. If the object actions are not performed, the data capture device 205 may cause the POS to perform an intervention operation, such requesting customer service assistance for the user, replaying the scanning instructions, preventing use of the POS until the scanning instructions are performed, and/or any other suitable intervention operation.

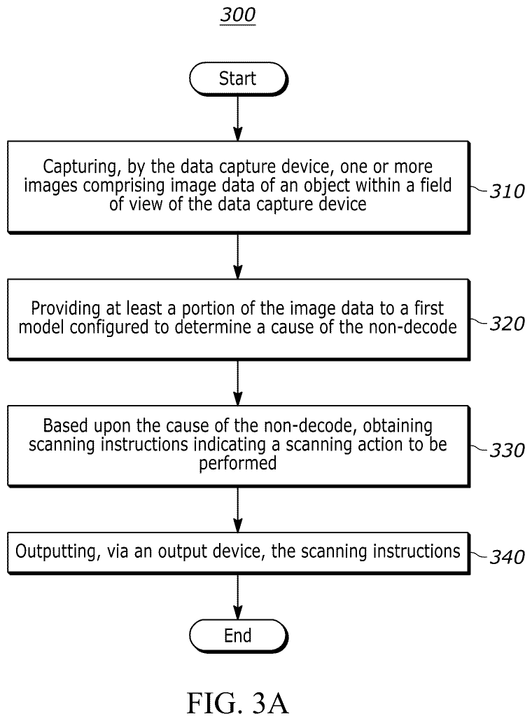

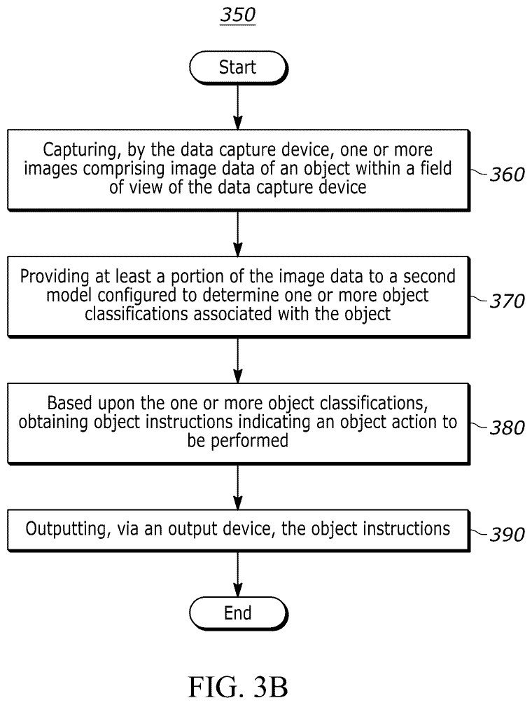

FIG. 3A illustrates a flow diagram of a first example method 300 for providing assistance during use of a data capture device (e.g., the data capture device 205), in accordance with embodiments disclosed herein. The method 300 may be performed, for example, by one or more components of the computing environment 200. The method 300 may include capturing, by the data capture device, one or more images comprising image data of an object (e.g., the object 104) within a field of view of the data capture device (block 310). The object may be associated with an indicia (e.g., the barcode 116) that is captured in the image data, and analysis of the one or images may result in a non-decode of the indicia.

The method 300 may include providing at least a portion of the image data to a first model (e.g., the models 230) configured to determine a cause of the non-decode (block 320). The cause of the non-decode may include one or more of: a distance of the indicia from the data capture device, symbology of the indicia, a substrate of the indicia, a size of the indicia, an incomplete indicia, or contrast of the indicia. In at least some embodiments where the cause of the non-decode is the symbology of the indicia, the method 300 may include obtaining symbology data to decode the symbology of the indicia. The first model may include a neural network.

The method 300 may include, based upon the cause of the non-decode, obtaining scanning instructions (e.g., from the memory 204, a database, the first model, the host 210) indicating a scanning action to be performed (block 330), wherein the scanning action is associated with resolving the cause of the non-decode of the indicia. The scanning instructions may include one or more of: audio, an image, text, or video. The scanning action may be associated with a location of the object respective to a scanning area and/or a position of the object during image capture.

The method 300 may include outputting, via an output device (e.g., the output device 218), the scanning instructions (block 340).

In at least some embodiments, the method 300 may include, based upon the non-decode, changing an operational characteristic of the data capture device associated with one or more of illumination, a focal setting, an image sensor setting, or image processing.

In at least some embodiments, the method 300 may include initiating a manual entry function of a user interface (e.g., via the I/O interface 216) associated with the data capture device; receiving, via the user interface, object information associated with a known object; identifying the object based upon the captured image data of the object; determining whether the object is the known object based upon the object information and identifying the object; responsive to the object being the known object, causing a POS device to receive a payload including the object information from the data capture device; and responsive to the object not being the known object, causing the POS device to perform an intervention operation.

FIG. 3B illustrates a flow diagram of a second example method 350 for providing assistance during use of a data capture device (e.g., the data capture device 205), in accordance with embodiments disclosed herein. The method 350 may be performed, for example, by one or more components of the computing environment 200. The method 350 may include capturing, by the data capture device (e.g., the data capture device 205), one or more images comprising image data of an object (e.g., the object 104) within a field of view of the data capture device (block 360).

The method 350 may include providing at least a portion of the image data to a second model (e.g., the models 230) configured to determine one or more object classifications associated with the object (block 370). The one or more object classifications may be based upon one or more of: a characteristic of packaging of the object, a characteristic of an indicia associated with the object, a size of the object, or a shape of the object.

In at least some embodiments, based upon the one or more object classifications, the method 350 may include changing an operational characteristic of the data capture device associated with one or more of: illumination, a focal setting, an image sensor setting, or image processing. In at least some embodiments, providing the image data to the second model may be responsive to one or more of: exceeding a threshold number of image captures of the object without a successful decode of an associated indicia (e.g., the barcode 116), exceeding a threshold time for scanning the object without the successful decode of the associated indicia, or a missed scan event.

The method 350 may include, based upon the one or more object classifications, obtaining object instructions indicating an object action to be performed (block 380), wherein the object action is associated with scanning the object across a scanning area within the field of view of the data capture device). The object action may be associated with an adjustment of packaging of the object and/or a position of the object during image capture. The object instructions may include one or more of: audio, an image, text, or video. The second model may include a neural network.

The method 350 may include outputting, via an output device (e.g., the output device 218), the object instructions (block 390). The object instructions may be output to the output device before scanning of the object across the scanning area.

In at least some embodiments, the method 350 may include initiating a manual entry function of a user interface (e.g., via the I/O interface 216) associated with the data capture device; receiving, via the user interface, object information associated with a known object; identifying the object based upon the captured image data of the object; determining whether the object is the known object based upon the object information and identifying the object; responsive to the object being the known object, causing a point-of-sale device to receive a payload including the object information from the data capture device; and responsive to the object not being the known object, causing the point-of-sale device to perform an intervention operation.

It should be understood that not all blocks of the example methods 300, 350 are required to be performed, nor are they required to be performed in the order described and/or presented in FIGS. 3A and/or 3B.

### ADDITIONAL CONSIDERATIONS

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises. a”, “has. a”, “includes. a”, “contains. a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A system for providing assistance during a use of a data capture device, the system comprising:
one or more processors; and
a memory storing instructions that, when executed by the one or more processors, cause the one or more processors to:
capture, by the data capture device, one or more images comprising image data of an object within a field of view of the data capture device, wherein:
the object is associated with an indicia that is captured in the image data, and
analysis of the one or more images results in a non-decode of the indicia;
provide at least a portion of the image data to a first model configured to determine a cause of the non-decode;
based upon the cause of the non-decode, obtain scanning instructions indicating a scanning action to be performed, wherein the scanning action is associated with resolving the cause of the non-decode of the indicia; and
output, via an output device, the scanning instructions.

2. The system of claim 1, wherein the cause of the non-decode includes one or more of: a distance of the indicia from the data capture device, symbology of the indicia, a substrate of the indicia, a size of the indicia, an incomplete indicia, or contrast of the indicia.

3. The system of claim 2, wherein:
the cause of the non-decode is the symbology of the indicia; and
the system further comprising instructions that, when executed by the one or more processors, cause the one or more processors to obtain symbology data to decode the symbology of the indicia.

4. The system of claim 1, further comprising instructions that, when executed by the one or more processors, cause the one or more processors to:
based upon the non-decode, change an operational characteristic of the data capture device associated with one or more of: illumination, a focal setting, an image sensor setting, or image processing.

5. The system of claim 1, wherein the scanning action is associated with a location of the object respective to a scanning area and/or a position of the object during image capture.

6. The system of claim 1, wherein the scanning instructions include one or more of: audio, an image, text, video, and/or an indication of a scanning location.

7. The system of claim 1, wherein the first model includes a neural network.

8. The system of claim 1, further comprising instructions that, when executed by the one or more processors, cause the one or more processors to:
initiate a manual entry function of a user interface associated with the data capture device;
receive, via the user interface, object information associated with a known object;
identify the object based upon the captured image data of the object;
determine whether the object is the known object based upon the object information and identifying the object;
responsive to the object being the known object, cause a point-of-sale device to receive a payload including the object information from the data capture device; and
responsive to the object not being the known object, cause the point-of-sale device to perform an intervention operation.

9. The system of claim 8, wherein the intervention operation includes one or more of: requesting user assistance, providing instructions, preventing user operation of a point-of-sale, or changing operational characteristics of the data capture device.

10. The system of claim 1, further comprising instructions that, when executed by the one or more processors, cause the one or more processors to:
determine whether the scanning instructions are performed; and
responsive to the scanning instructions not being performed, cause a point-of-sale device to perform an intervention operation.

11. A method for providing assistance during a use of a data capture device, the method comprising:
capturing, by the data capture device, one or more images comprising image data of one of an object within a field of view of the data capture device, wherein:
the object is associated with an indicia that is captured in the image data, and
analysis of the one or more images results in a non-decode of the indicia;
providing at least a portion of the image data to a first model configured to determine a cause of the non-decode;
based upon the cause of the non-decode, obtaining scanning instructions indicating a scanning action to be performed, wherein the scanning action is associated with resolving the cause of the non-decode of the indicia; and
outputting, via an output device, the scanning instructions.

12. The method of claim 11, wherein the cause of the non-decode includes one or more of: a distance of the indicia from the data capture device, symbology of the indicia, a substrate of the indicia, a size of the indicia, an incomplete indicia, or contrast of the indicia.

13. The method of claim 12, wherein:
the cause of the non-decode is the symbology of the indicia; and
the method further comprising obtaining symbology data to decode the symbology of the indicia.

14. The method of claim 11, further comprising:
based upon the non-decode, changing an operational characteristic of the data capture device associated with one or more of: illumination, a focal setting, an image sensor setting, or image processing.

15. The method of claim 11, wherein the scanning action is associated with a location of the object respective to a scanning area and/or a position of the object during image capture.

16. The method of claim 11, wherein the scanning instructions include one or more of: audio, an image, text, or video.

17. The method of claim 11, wherein the first model includes a neural network.

18. The method of claim 11, further comprising:
initiating a manual entry function of a user interface associated with the data capture device;
receiving, via the user interface, object information associated with a known object;
identifying the object based upon the captured image data of the object;
determining whether the object is the known object based upon the object information and identifying the object;
responsive to the object being the known object, causing a point-of-sale device to receive a payload including the object information from the data capture device; and
responsive to the object not being the known object, causing the point-of-sale device to perform an intervention operation.

19. The method of claim 18, wherein the intervention operation includes one or more of: requesting user assistance, providing instructions, preventing user operation of a point-of-sale, or changing operational characteristics of the data capture device.

20. The method of claim 11, further comprising:
determining whether the scanning instructions are performed; and
responsive to the scanning instructions not being performed, causing a point-of-sale device to perform an intervention operation.

21-42. (canceled)
